(19) United States
(12) Patent Application Publication
(10) Pub. No.: US 2013/0269290 A1
(43) Pub. Date: Oct. 17, 2013

(54) TOWER REINFORCEMENT SYSTEMS AND METHODS

(71) Applicant: SABRE COMMUNICATIONS CORPORATION, Sioux City, IA (US)

(72) Inventor: Carlo Umberto Franceschino, London (CA)

(73) Assignee: Sabre Communications Corporation, Sioux City, IA (US)

(21) Appl. No.: 13/839,478

(22) Filed: Mar. 15, 2013

Related U.S. Application Data
(60) Provisional application No. 61/625,563, filed on Apr. 17, 2012.

(51) Int. Cl. H01Q 1/12

(52) U.S. Cl. CPC H01Q 1/1242
USPC 52/854

(57) ABSTRACT

An example includes a telecommunications tower that includes an elongate pole, a first pole brace bolted to the outer surface of the elongate pole with at least one first bolt, a second pole brace bolted to the at least one side of the elongate pole as the first pole brace with at least one second bolt, with the first pole brace disposed proximal the first pole brace with the first edge disposed proximal to second edge to abut the second edge during elastic deformation of the elongate pole in a first direction, a plate coupled to the first pole brace; and a bearing plate coupled to the second pole brace to removably bear against one side of the plate to transmit load between the first pole brace and the second pole brace during elastic deformation of the elongate pole in a second direction, opposite the first.

### CLAIM OF PRIORITY

This patent application claims the benefit of priority of U.S. Provisional Patent Application Ser. No. 61/625,563 to Franceschino entitled “TOWER REINFORCEMENT SYSTEMS AND METHODS,” filed on Apr. 17, 2012 (Attorney Docket No. 1496.006US1), which is hereby incorporated by reference herein in its entirety.

### BACKGROUND

Single-pole towers, also referred to as monopole towers, are used in the telecommunications industry. In particular, such towers are used to support equipment for wireless phones and other communication devices.

The increase in wireless communications has resulted in an increase of mounted communication equipment of all kinds. Not only do wireless service providers need to install equipment covering geographic areas, competing wireless service providers need to install additional equipment covering the same or similar geographic areas. The solution to the foregoing problem can be to either purchase additional land to erect towers, or install additional equipment on existing towers. Purchasing land to install additional towers can be increasingly expensive, as well as the expense associated with the construction and the maintenance of a tower.

Towers are designed generally to support the weight of the communications equipment originally installed on the tower, as well as to withstand forces exerted on the tower by environmental factors, such as wind and ice, for example. Towers are generally not designed with sufficient strength to enable the tower to allow for the installation of additional equipment. As a result, prior art methods of increasing the strength of the tower in order to support additional equipment are known to consist basically of familiar, expected and obvious structural configurations, typically reinforcing the weak area of the tower by adding additional material to the tower and attaching it by welding or using bolt connections.

### Overview

In light of the above, it can be appreciated that there exists a continuing need for an apparatus and method for increasing the load capacity and stability of a tower to enable the tower to support the weight of additional communication equipment as well as the environmental forces exerted on the tower.

By way of example, the present disclosure describes systems and methods of transferring load from one portion of a pole, such as a monopole, to a second portion of the pole, without bolting the two portions directly together via a reinforcing plate, and without bolting a splice plate to one or both of two reinforcing plates attached to the pole.

The present inventors have recognized, among other things, that a problem to be solved can include retrofitting reinforcements to a tower to transmit load between two portions of a tower without relying on bolting the two portions together. The present subject matter can help provide a solution to this problem, such as by providing a load bearing configuration in which a bearing plate coupled to a first pole brace can removably bear against one side of a plate coupled to a second pole brace to transmit load between the first pole brace and the second pole brace during elastic deformation of the elongate pole.

An example includes a telecommunications tower that includes an elongate pole, a first pole brace bolted to the outer surface of the elongate pole with at least one first bolt, a second pole brace bolted to the at least one side of the elongate pole as the first pole brace with at least one second bolt, with the first pole brace disposed proximal the first pole brace with the first edge disposed proximal to second edge to abut the second edge during elastic deformation of the elongate pole in a first direction, a plate coupled to the first pole brace; and a bearing plate coupled to the second pole brace to removably bear against one side of the plate to transmit load between the first pole brace and the second pole brace during elastic deformation of the elongate pole in a second direction, opposite the first.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1C show views of structural members spliced together with a weld, according to an example.

FIGS. 2A-D show views of structural members spaced apart from one another, with a misaligned seam, according to an example.

FIGS. 3A-N show views of a tower 300 with tubular pipe sleeves added to structural members, according to an example.

FIGS. 4A-H show views of a plate combined with one or more tubular members, according to an example.

FIGS. 5A-D show views of a structural member with a plate welded to it, according to an example.

FIGS. 6A-6D show views of a load bearing assembly including side plates, according to an example.

FIGS. 7A-7D show views of a load bearing assembly including a plate, according to an example.

FIGS. 8A-8D show views of a load bearing assembly including multiple plates, according to an example.

FIGS. 9A-F show views of a reinforcement including two attached plates, according to an example.

FIGS. 10A-D show views of a splice plate attached with bolts, according to an example.

FIGS. 11A-D show views of a splice plate attached with welds, according to an example.

FIGS. 12A-D show views of a splice plate overlapping two structural members and attached to one, according to an example.

FIGS. 13A-D show views of a splice plate overlapping two structural members and attached to one, according to an example.

### DETAILED DESCRIPTION

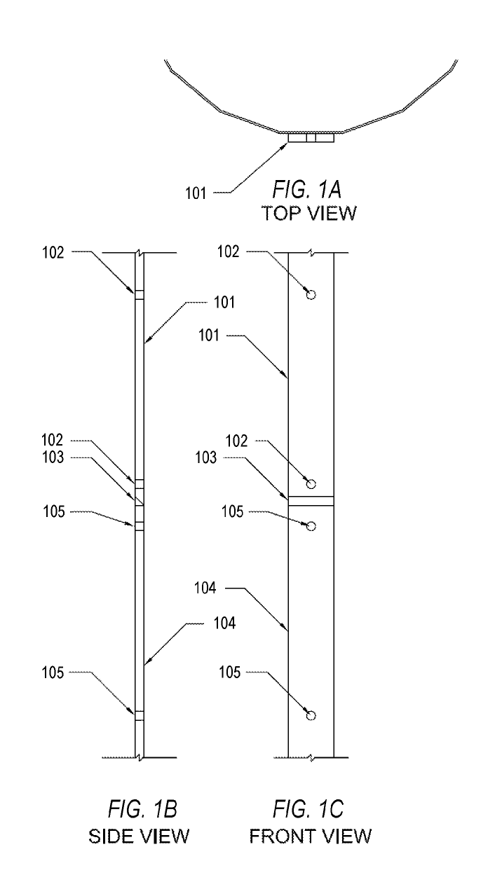

FIGS. 1A-1C show views of structural members spliced together with a weld, according to an example. A method for splicing a structural member or brace can be used to reinforce a monopole or other structural member or brace as shown. The figures can be associated with a method of splicing a structural member can be used to reinforce a round monopole, multi-sided monopole or other type of structural member. The round monopole, multi-sided monopole or other type of structural member can benefit from reinforcing to strengthen or increase the stiffness of the member to satisfy increased loading and/or to limit deflections.

The desired length of structural members for reinforcing a monopole or other structural member can exceed the commercially available lengths of the structural members available because of limitations, such as, but not limited to, available material lengths, shipping and fabrication capabilities. When a desired length exceeds a commercially available length, a splice connecting one piece of structural member to another can be used.

In FIG. 1 the structural members 101 and 104 can be spliced with a weld 103. The weld 103 can be completed in a fabrication shop or in the field. The structural member can be connected directly to the round monopole, multi-sided monopole or other type of structural member via holes 102 and 105 in the structural members 101 and 104. Bolts, such as one-sided bolts, studs, welds or other types of attachments can be used to connect the structural member to the round monopole, multi-sided monopole or other type of structural member.

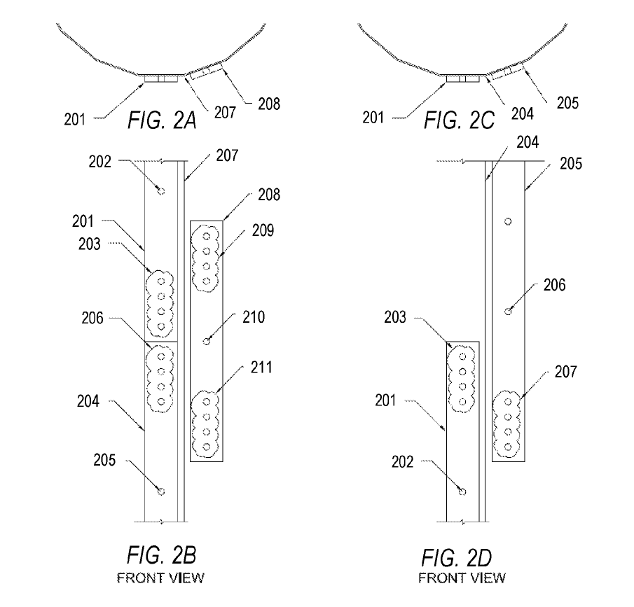

FIGS. 2A-D show views of structural members spaced apart from one another, with a misaligned seam, according to an example. A method for splicing a structural member can be used to reinforce a monopole or other structural member as shown. The figures can be associated with a method of transferring load from one structural member such as a reinforcing member to another, to reinforce a round monopole, multi-sided monopole or other type of structural member. The round monopole, multi-sided monopole or other type of structural member can benefit from reinforcing to strengthen or increase the stiffness of the member to satisfy increased loading and/or to limit deflections.

The desired length of structural members for reinforcing a monopole or other structural member can exceed the commercially available lengths of the structural members available because of limitations, such as, but not limited to, available material lengths, shipping and fabrication capabilities. When the desired length exceeds the commercially available length, a splice connecting one piece of structural member to another can be used.

In the FIGS. 2A and 2C, the structural members 201 and 204 can optionally be spaced apart from one another. They can optionally abut, i.e., physically touch. Termination connections 203 and 206 can be used to transfer load in the structural member to a monopole or another structural member. An additional piece of structural material 208 can be added beside the other structural members 201 and 204 such that the terminations connections 209 and 211 can be placed such that the load can be transferred and the underlying structure can be reinforced, such as continuously reinforced. The seam 207, such as on a multi-sided monopole, represents that the plates 201 and 204 can be on different sides of the monopole than the additional structural member 208. The structural members can be connected directly to the round monopole, multi-sided monopole or other type of structural member via holes 202, 205, 210 and holes in the termination connections 203, 206, 209 and 211 in the structural members 201, 204 and 208. Bolts, such as one-sided bolts, studs, welds or other types of attachments can be used to connect the structural member to the round monopole, multi-sided monopole or other type of structural member.

In the FIGS. 2C and 2D, the structural members 201 and 205 may not be directly connected to one another. They can be disposed on different sides of a multi-sided pole. The seam 204 on a multi-sided monopole indicates that the plates 201 and 205 can be on different sides of the monopole and not vertically aligned. Other member placement configurations on one or more surfaces are additionally possible.

Termination connections 203 and 207 can be used to transfer the load in a structural member back to a monopole or another structural member and can be placed such that the load can be transferred and the underlying structure can be reinforced, such as continuously reinforced. The structural members can be connected directly to the round monopole, multi-sided monopole or other type of structural member via holes 202 and 206 and holes in the termination connections 203 and 207 in the structural members 201 and 205. Bolts, such as one-sided bolts, studs, welds or other types of attachments can be used to connect the structural member to the round monopole, multi-sided monopole or other type of structural member.

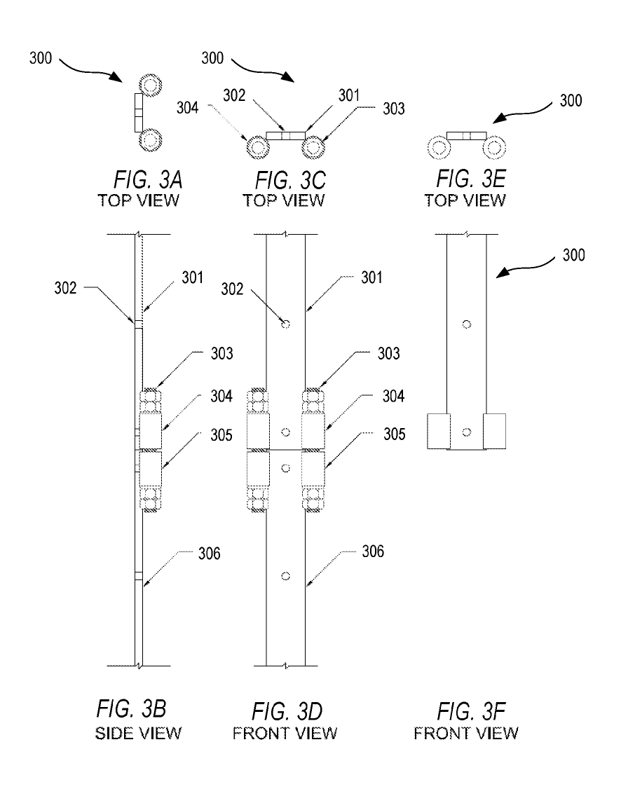

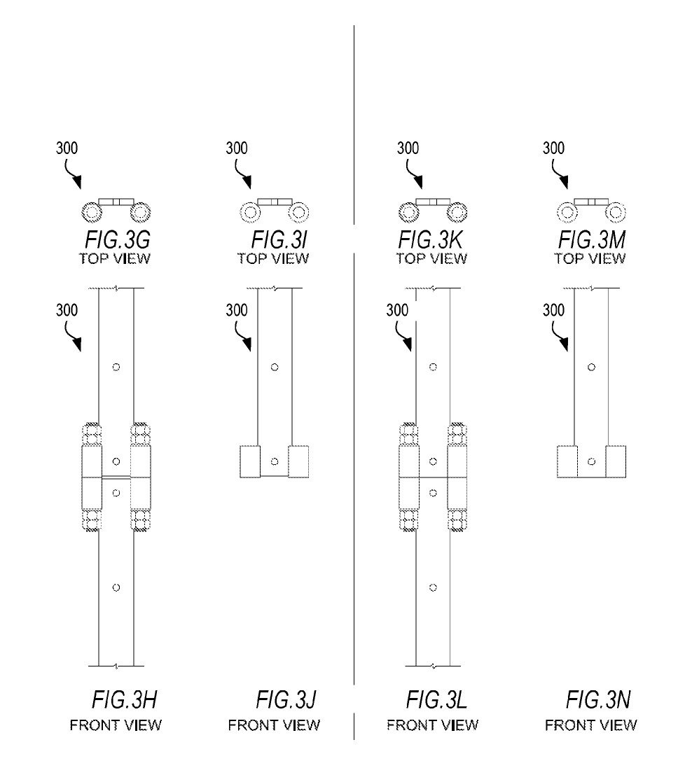

FIGS. 3A-F show views of a tower 300 with tubular pipe sleeves added to structural members, according to an example. A method for splicing a structural member can be used to reinforce a monopole or other structural member. The figures can be used with a method of transferring load from one structural member such as a reinforcing member to another, to reinforce a round monopole, multi-sided monopole or other type of structural member. The round monopole, multi-sided monopole or other type of structural member can benefit from reinforcing to strengthen or increase the stiffness of the member to satisfy increased loading and/or to limit deflections.

The desired length of structural members for reinforcing a monopole or other structural member can exceed the commercially available lengths of the structural members available because of limitations, such as, but not limited to, available material lengths, shipping and fabrication capabilities. When the desired length exceeds the commercially available length, a splice connecting one piece of structural member to another can be used.

In FIGS. 3A-3D, the structural members 301 and 306 can optionally be spaced apart from one another. They can optionally abut, i.e., physically touch. Tubular pipe sleeves 304 and 305 can be added to the structural members 301 and 306 respectively. Bolt assemblies (e.g., bolts, washers and nuts) or threaded rod assemblies (e.g., threaded rods, washers and nuts) 303 can attach sleeves 304 to additional sleeves 305. In FIGS. 3A-3D, the structural members 301 and 306 can bear onto, such as directly onto, in contact or in moment contact, one another to provide a load transfer mechanism, such as when the plates are in compression. The bolt or threaded rod assemblies 303 can provide a load transfer mechanism, such as when the plates are in tension. FIGS. 3E and 3F show the upper member 301 with attached sleeves 304 but optionally without the bolt or threaded rod assemblies 303. The structural members can be connected directly to the round monopole, multi-sided monopole or other type of structural member via holes 302. Bolts, such as one-sided bolts, studs, welds or other types of attachments can be used to connect the structural member to the round monopole, multi-sided monopole or other type of structural member.

In FIGS. 3G-3J, the sleeves can bear directly on one another to provide a load transfer mechanism when the plates are in compression (e.g., when the plates are not in contact) and the bolt or threaded rod assemblies 303 can provide a load transfer mechanism when the plates are in tension.

In FIGS. 3K-3N, the sleeves and plates can bear directly on one another to provide a load transfer mechanism when the plates are in compression and the bolt or threaded rod assemblies 303 can provide a load transfer mechanism when the plates are in tension.

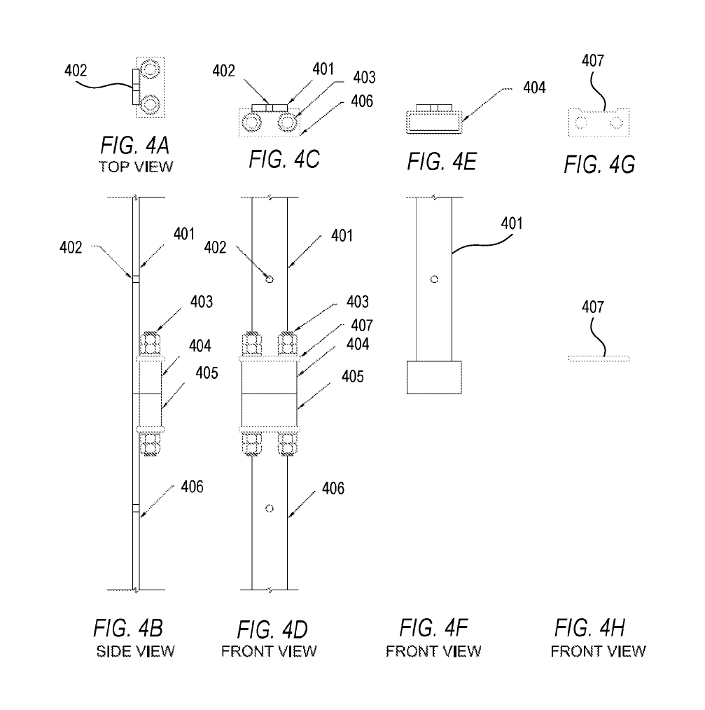

FIGS. 4A-H show views of a plate combined with one or more tubular members, according to an example. The example can be used with a method for splicing a structural member used to reinforce a monopole or other structural member. The figures can be used with a method of transferring load from one structural member such as a reinforcing member to another, to reinforce a round monopole, multi-sided monopole or other type of structural member. The round monopole, multi-sided monopole or other type of structural member can benefit from reinforcing to strengthen or increase the stiffness of the member to satisfy increased loading and/or to limit deflections.

The desired length of structural members for reinforcing a monopole or other structural member can exceed the commercially available lengths of the structural members available because of limitations, such as, but not limited to, available material lengths, shipping and fabrication capabilities. When the desired length exceeds the commercially available length, a splice connecting one piece of structural member to another can be used.

The structural members 401 and 406 can optionally be spaced apart from one another. They can optionally abut, i.e., physically touch. Tubular sleeves 404 and 405 can be added to the structural members 401 and 406 respectively. Bolt assemblies (e.g., bolts, such as one-sided bolts, washers and nuts) or threaded rod assemblies 403 (e.g., threaded rods, washers and nuts) can combine with top and bottom plates 407 and optionally can attach sleeves 404 to additional sleeves 405. The structural members 401 and 406 and the sleeves 404 and 405 can bear, such as directly, on one another to provide a load transfer mechanism, such as when the plates are in compression. The bolt or threaded rod assemblies 403 can provide a load transfer mechanism, such as when the plates are in tension. FIGS. 4E and 4F show the upper member 402 with attached sleeves 404 but optionally without the bolt or threaded rod assemblies 403 or the top and bottom plates 407. FIGS. 4G and 4H show the top and bottom plate 407. The structural members can be connected directly to the round monopole, multi-sided monopole or other type of structural member via holes 402. Bolts, such as one-sided bolts, studs, welds or other types of attachments can be used to connect the structural member to the round monopole, multi-sided monopole or other type of structural member.

Some examples can have only the structural members 401 and 406. Some examples can have only the tubular sleeves 404 and 405 bearing directly on each other to provide a load transfer mechanism when the plates are in compression.

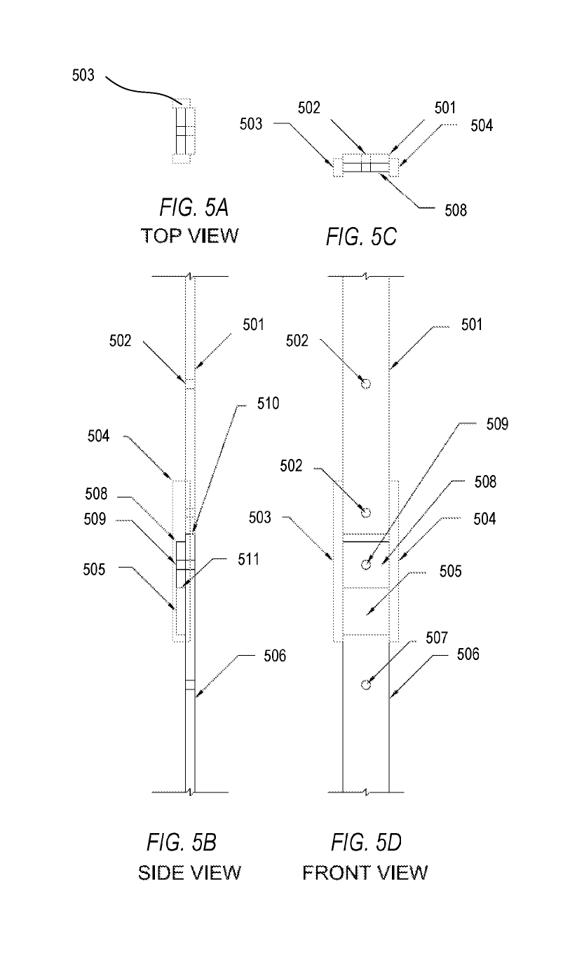

FIGS. 5A-D show views of a structural member with a plate welded to it, according to an example. A method for splicing a structural member can be used to reinforce a monopole or other structural member. The figures can be used with a method of transferring load from one structural member to another that can be used to reinforce a round monopole, multi-sided monopole or other type of structural member. The round monopole, multi-sided monopole or other type of structural member may require reinforcing to strengthen or increase the stiffness of the existing member to satisfy increased loading and/or to limit deflections.

The length of the structural members that can be added to the existing monopole or other structural member may exceed the lengths of the structural members because of limitations, such as, but not limited to, available material lengths, shipping and fabrication capabilities. When the length exceeds the available length, a method of transferring the load from one piece of structural member to another is used.

In the Figures, the structural members 501 and 506 can be connected to one another such that load transfer between the two plates occurs in bearing connections when the plates are in compression or tension. The first assembly can be made up of the structural member 506 with a plate 508 welded to it. The second assembly can be made up of the structural member 501 with two side plates 503 and 504 welded to it and the side plates 503 and 504 then welded to a bearing plate 505.

When the structural members are in compression, the structural member 501 can bear directly on the structural member 506 at the location shown 510. When the structural members are in tension, the loads can be transferred, such as directly, e.g. without putting bolts in shear, from the structural member 501 then through side plates 503 and 504 then to the bearing plate 505. The bearing plate 505 can transfer the load in bearing at the location shown 511 to the plate 508 and then finally to plate 506. The structural members can be connected directly to the existing round monopole, multi-sided monopole or other type of structural member via holes 502 and 507. Bolts, studs, welds or other types of attachments can be used to connect the structural member to the existing round monopole, multi-sided monopole or other type of structural member.

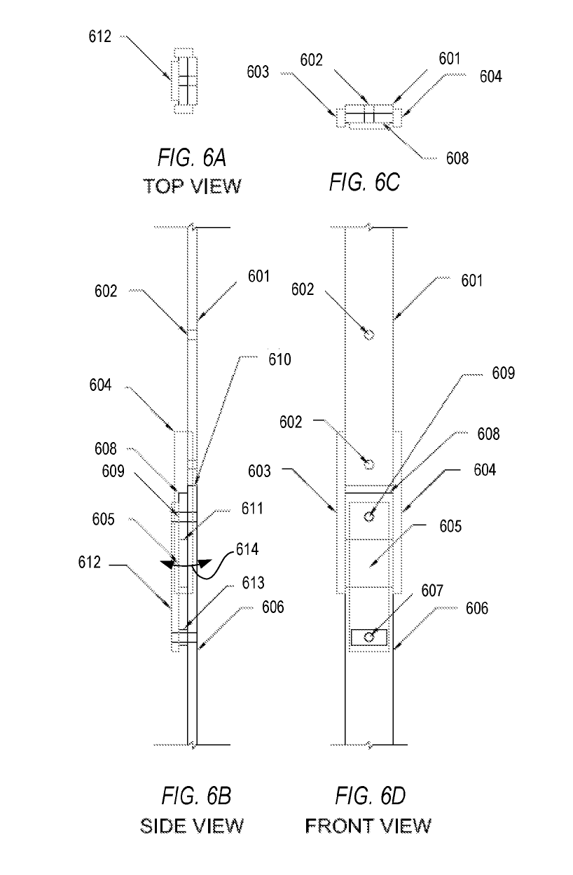

FIGS. 6A-6D show views of a load bearing assembly including side plates, according to an example. A method for splicing a structural member can be used to reinforce a monopole or other structural member. The figures can be used with a method of transferring load from one structural member to another that can be used to reinforce a round monopole, multi-sided monopole or other type of structural member. The round monopole, multi-sided monopole or other type of structural member may require reinforcing to strengthen or increase the stiffness of the existing member to satisfy increased loading and/or to limit deflections.

The length of the structural members that can be added to the existing monopole or other structural member may exceed the lengths of the structural members because of limitations, such as, but not limited to, available material lengths, shipping and fabrication capabilities. When the length exceeds the available length, a method of transferring the load from one piece of structural member to another can be used.

In the Figures, the structural members 601 and 606 can be connected to one another such that load transfer between the two plates occurs in bearing connections when the plates are in compression or tension. The first assembly can be made up of the structural member 606 with a plate 608 welded to it. The second assembly can be made up of the structural member 601 with two side plates 603 and 604 welded to it and the side plates 603 and 604 then welded to a bearing plate 605.

When the structural members are in compression, the structural member 601 can bear directly on the structural member 606 at the location shown 610. When the structural members are in tension, the loads can be transferred, such as directly, e.g. without putting bolts in shear, from the structural member 601 then through side plates 603 and 604 then to the bearing plate 605. The bearing plate 605 can transfer the load in bearing at the location shown 611 to the plate 608 and then finally to plate 606. The structural members can be connected directly to the existing round monopole, multi-sided monopole or other type of structural member via holes 602 and 607. Bolts, studs, welds or other types of attachments can be used to connect the structural member to the existing round monopole, multi-sided monopole or other type of structural member.

This figures show members 612 and 613 that can be welded together. Their function can be to lock the bearing plate 605 in place to reduce the amount of rotation 614 in the connection. This can result in additional strength. Overplate or member 612 can sit on plate 608 which can be welded to plate 606. All three can be connected together. They can be connected to the underlying structural member that is being reinforced. At the other end, member 612 can be welded to member 613 and they can sit on plate 606. All three can be connected together. They can be connected to the underlying structural member that is being reinforced.

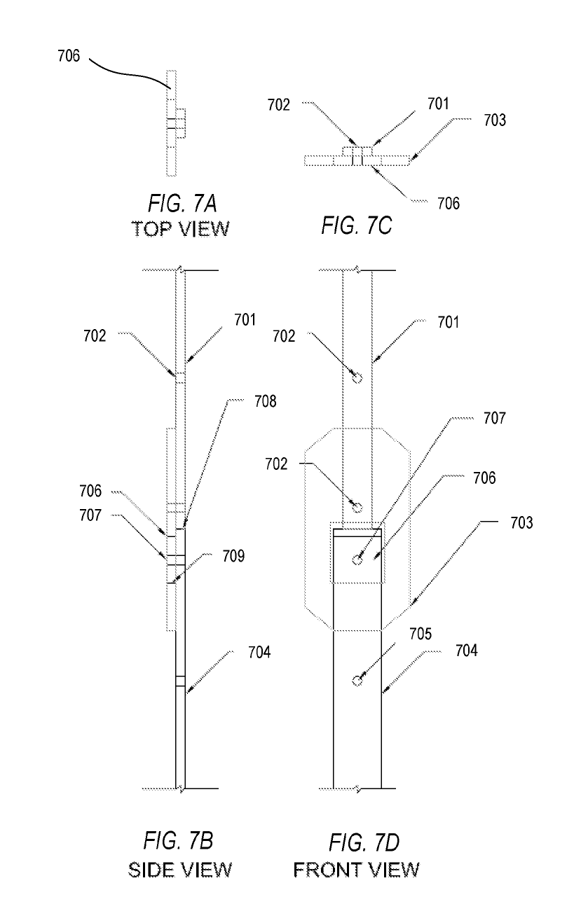

FIGS. 7A-7D show views of a load bearing assembly including a plate, according to an example. A method for splicing a structural member can be used to reinforce a monopole or other structural member. The figures can be used with a method of transferring load from one structural member to another that can be used to reinforce a round monopole, multi-sided monopole or other type of structural member. The round monopole, multi-sided monopole or other type of structural member may require reinforcing to strengthen or increase the stiffness of the existing member to satisfy increased loading and/or to limit deflections.

The length of the structural members that can be added to the existing monopole or other structural member may exceed the lengths of the structural members because of limitations, such as, but not limited to, available material lengths, shipping and fabrication capabilities. When the length exceeds the available length, a method of transferring the load from one piece of structural member to another can be used.

In the Figures, the structural members 701 and 704 can be connected to one another such that load transfer between the two plates occurs in bearing connections when the plates are in compression or tension. The first assembly can be made up of the structural member 704 with a plate 706 welded to it. The second assembly can be made up of the structural member 701 with a plate 703 that can be fastened to it, such as by bolting and/or welding it to the underlying structural member that is being reinforced.

When the structural members are in compression, the structural member 701 can bear directly on the structural member 704 at the location shown 708. When the structural members are in tension, the loads can be transferred, such as directly, e.g. without putting bolts in shear, from the structural member 701 then through plate 703. The plate 703 can transfer the load in bearing at the location shown 709 to the plate 706 and then finally to plate 704. The structural members can be connected directly to the existing round monopole, multi-sided monopole or other type of structural member via holes 702 and 705. Bolts, studs, welds or other types of attachments can be used to connect the structural member to the existing round monopole, multi-sided monopole or other type of structural member.

One benefit of this design is that it is easy to adapt to plates of varying sizes and it can also be used for plates that are already in place.

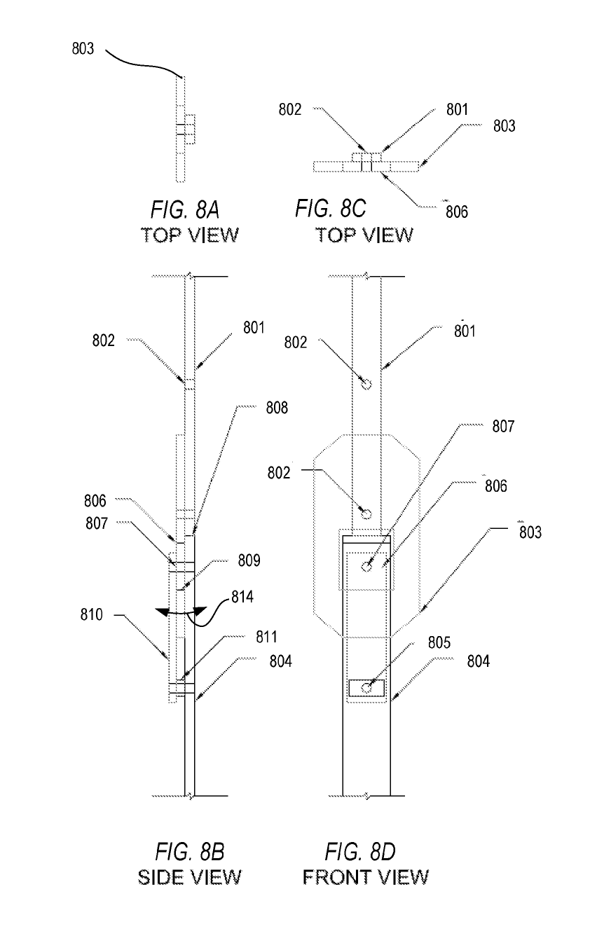

FIGS. 8A-8D show views of a load bearing assembly including multiple plates, according to an example. A method for splicing a structural member can be used to reinforce a monopole or other structural member. The figures can be used with a method of transferring load from one structural member to another that can be used to reinforce a round monopole, multi-sided monopole or other type of structural member. The round monopole, multi-sided monopole or other type of structural member may require reinforcing to strengthen or increase the stiffness of the existing member to satisfy increased loading and/or to limit deflections.

The length of the structural members that can be added to the existing monopole or other structural member may exceed the lengths of the structural members because of limitations, such as, but not limited to, available material lengths, shipping and fabrication capabilities. When the length exceeds the available length, a method of transferring the load from one piece of structural member to another can be used.

In the Figures, the structural members 801 and 804 can be connected to one another such that load transfer between the two plates occurs in bearing connections when the plates are in compression or tension. The first assembly can be made up of the structural member 804 with a plate 806 welded to it. The second assembly can be made up of the structural member 801 with a plate 803 that can be fastened to it, such as by bolting and/or welding it to the underlying structural member that is being reinforced.

When the structural members are in compression, the structural member 801 can bear directly on the structural member 804 at the location shown 808. When the structural members are in tension, the loads can be transferred, such as directly, e.g. without putting bolts in shear, from the structural member 801 then through plate 803. The plate 803 can transfer the load in bearing at the location shown 809 to the plate 806 and then finally to plate 804. The structural members can be connected directly to the existing round monopole, multi-sided monopole or other type of structural member via holes 802 and 805. Bolts, studs, welds or other types of attachments can be used to connect the structural member to the existing round monopole, multi-sided monopole or other type of structural member.

One benefit of this design is that it is easy to adapt to plates of varying sizes and it can also be used for plates that already in place.

This Figure includes members 810 and 811 that can be welded together. Their function can be to lock the plate 803 in place to reduce the amount of rotation 814 in the connection. This results in additional strength. Overplate or member 810 sits on plate 806 which can be welded to plate 804 and all three can be connected together and connected to the underlying structural member that is being reinforced. At the other end, member 810 can be welded to member 811 and they sit on plate 804 and all three can be connected together and connected to the underlying structural member that is being reinforced.

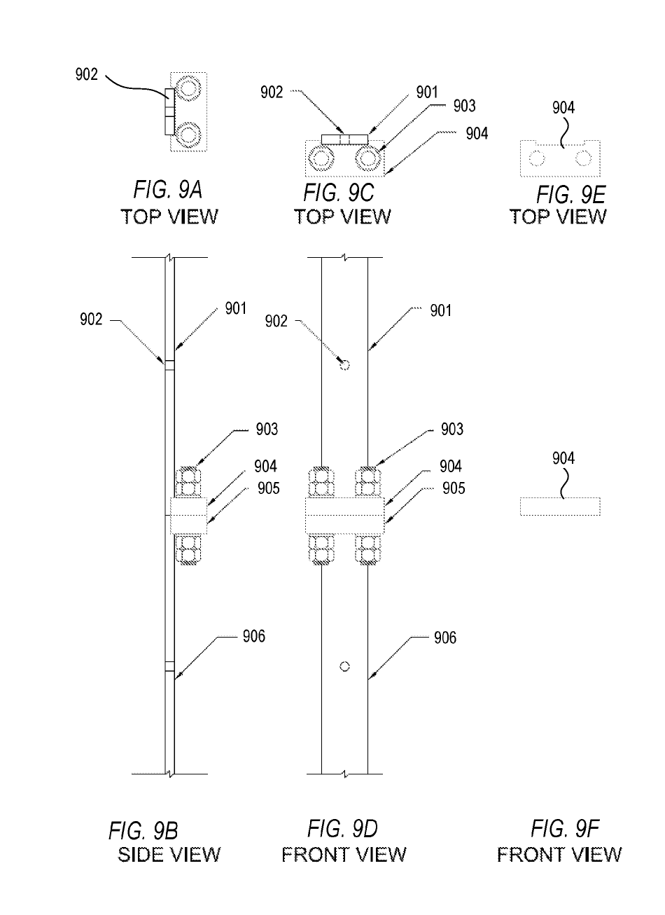

FIGS. 9A-F show views of a reinforcement including two attached plates, according to an example. A method for splicing a structural member can be used to reinforce a monopole or other structural member. The figures can be used with a method of transferring load from one structural member such as a reinforcing member to another, to reinforce a round monopole, multi-sided monopole or other type of structural member. The round monopole, multi-sided monopole or other type of structural member can benefit from reinforcing to strengthen or increase the stiffness of the member to satisfy increased loading and/or to limit deflections.

The desired length of structural members for reinforcing a monopole or other structural member can exceed the commercially available lengths of the structural members available because of limitations, such as, but not limited to, available material lengths, shipping and fabrication capabilities. When the desired length exceeds the commercially available length, a splice connecting one piece of structural member to another can be used.

In the Figures, the structural members 901 and 906 can be spaced apart from one another. They can optionally abut, i.e., physically touch. Plates 904 and 905 can be added to the structural members 901 and 906 respectively. Bolt assemblies (e.g., bolts, washers and nuts) or threaded rod assemblies (e.g., threaded rods, washers and nuts) 903 can attach plate 904 to plate 905. The structural members 901 and 906 and the plates 904 and 905 can bear directly on one another to provide a load transfer mechanism when the plates are in compression. The bolt or threaded rod assemblies 903 can provide a load transfer mechanism when the plates are in tension.

Figures 905 and 906 show the top and front view of plates 904 and 905. The structural members can be connected, such as directly, to the round monopole, multi-sided monopole or other type of structural member via holes 902. Bolts, such as one-sided bolts, studs, welds or other types of attachments can be used to connect the structural member to the round monopole, multi-sided monopole or other type of structural member.

Some examples can have only the structural members 901 and 906. Some examples can have only the plates 904 and 905 bearing directly on each other to provide a load transfer mechanism when the plates are in compression.

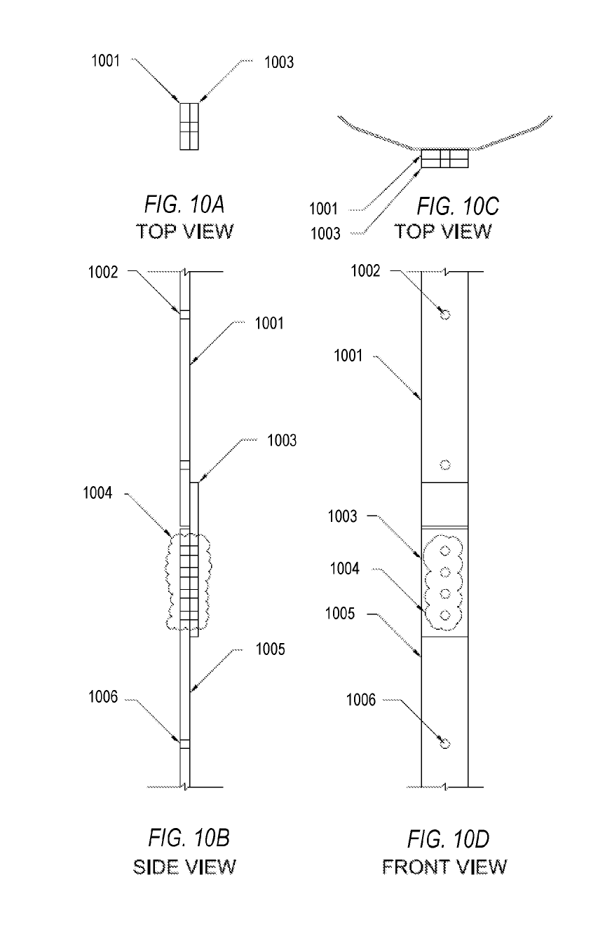

FIGS. 10A-D show views of a splice plate attached with bolts, according to an example. A method for splicing a structural member can be used to reinforce a monopole or other structural member. The figures can be used with a method of transferring load from one structural member to another.

Structural members 1001 and 1005 may not be directly connected to one another. Structural members 1001 and 1005 can be spaced apart from one another. A splice plate 1003 can be used to transfer the load from one structural member to the other structural member. Bolts 1004 can be added through the splice plate and one or both of the structural members 1001 and 1005. Bolts 1002 and 1006 or other types of attachments can be used to connect the structural members to the structure that is being reinforced. Bolts, such as one-sided bolts, studs, welds or other types of attachments can be used to connect the structural member to the round monopole, multi-sided monopole or other type of structural member.

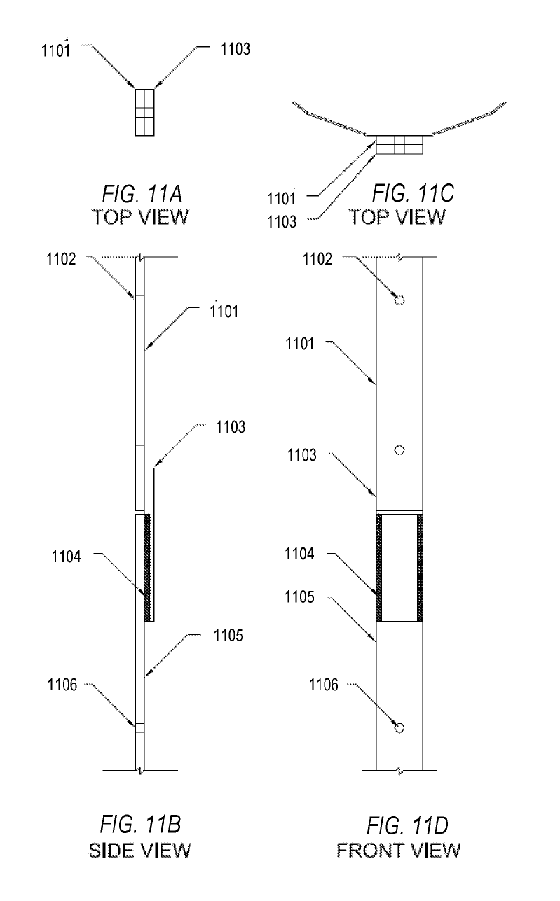

FIGS. 11A-D show views of a splice plate attached with welds, according to an example. A method of transferring load from one structural member to another can incorporate the shown structure. Structural members 1101 and 1105 can be spaced apart from one another. They can optionally abut, i.e., physically touch. A splice plate 1103 can be used to transfer the load from one structural member to the other structural member. Welds 1104 can be used to connect one or both of the structural members 1101 and 1105. Bolts 1102 and 1106 or other types of attachments can be used to connect the structural members to the structure that is being reinforced.

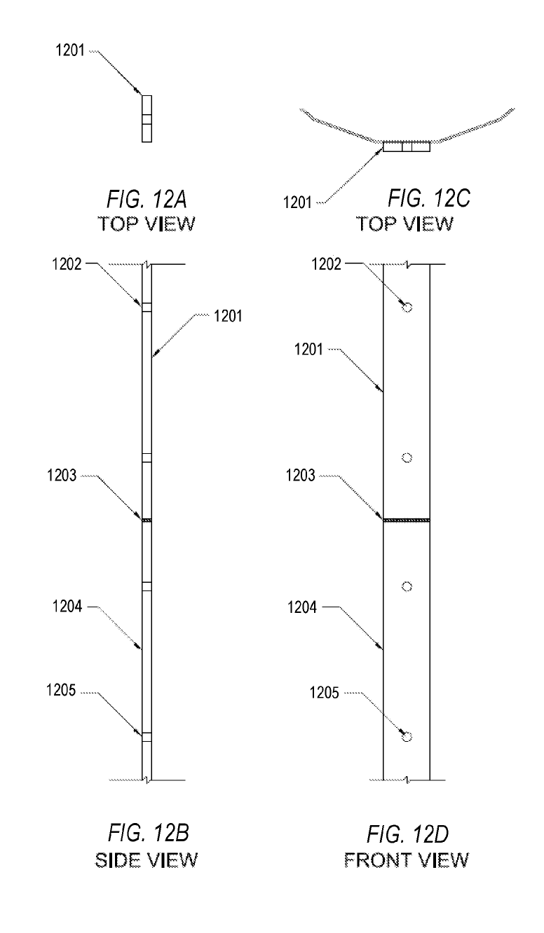

FIGS. 12A-D show views of a splice plate overlapping two structural members and attached to one, according to an example. The following Figures show an improved method of transferring load from one structural member to another. Structural members 1201 and 1204 can be spaced apart from one another. They can optionally abut, i.e., physically touch. A weld 1203 can be used to transfer the load from one structural member to the other structural member. Bolts 1202 and 1205 or other types of attachments can be used to connect the structural members to the structure that is being reinforced. Bolts, such as one-sided bolts, studs, welds or other types of attachments can be used to connect the structural member to the round monopole, multi-sided monopole or other type of structural member.

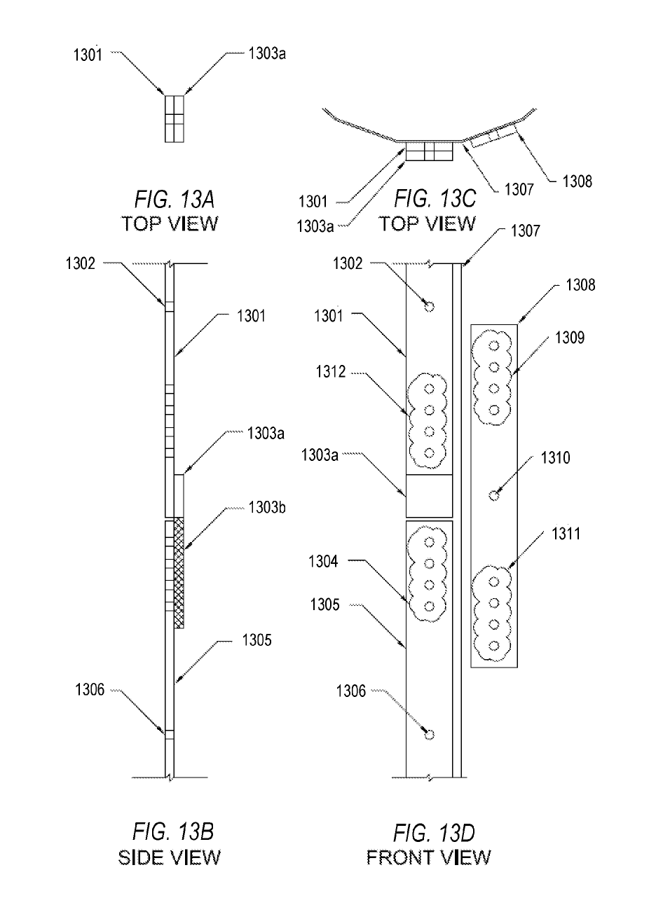

FIGS. 13A-D show views of a splice plate overlapping two structural members and attached to one, according to an example. The following Figures show an improved method of transferring load from one structural member to another. Structural members 1301 and 1305 can be spaced apart from one another. They can optionally abut, i.e., physically touch. The splice plate 1303 can be excised such as cut such as ground into two portions 1303a and 1303b. The bolts 1304 can be temporarily removed so that the portion 1303b of the splice can be removed. The bolts 1304 can be reinstalled. Termination bolts 1312 can be added and a structural member 1308 can be added on a separate side with termination bolts 1309 and 1311. Bolts 1302, 1306 and 1310 or other types of attachments can be used to connect the structural members to the structure that is being reinforced. Bolts, such as one-sided bolts, studs, welds or other types of attachments can be used to connect the structural member to the round monopole, multi-sided monopole or other type of structural member.

### Various Notes & Examples

Example 1 can include a telecommunications tower. An example can include an elongate pole including an exterior with at least one side. An example can include a first pole brace comprising an elongate plate, with an inner side, an outer side and a first edge extending between the inner side and the outer side, the first pole brace bolted to the exterior of the at least one side of the elongate pole with at least one first bolt such that the inner side of the first pole brace lies along a portion of the exterior of the at least one side of the elongate pole. An example can include a second pole brace comprising an elongate plate with an inner side, an outer side, and a second edge extending between the inner side and the outer side, the second pole brace bolted to the at least one side of the elongate pole as the first pole brace with at least one second bolt such that the inner side of the second pole brace lies along a portion of the exterior of the at least one side of the elongate pole, with the first pole brace disposed proximal the first pole brace with the first edge disposed proximal to second edge to abut the second edge during elastic deformation of the elongate pole in a first direction. An example can include a plate coupled to the first pole brace. An example can include a bearing plate coupled to the second pole brace to removably bear against one side of the plate to transmit load between the first pole brace and the second pole brace during elastic deformation of the elongate pole in a second direction, opposite the first.

Example 2 can include, or can optionally be combined with the subject matter of one or any combination of the preceding Examples, wherein the bearing plate is bolted to the second pole brace with at least one bolt.

Example 3 can include, or can optionally be combined with the subject matter of one or any combination of the preceding Examples, wherein the at least one bolt comprises a one-sided bolt.

Example 4 can include, or can optionally be combined with the subject matter of one or any combination of the preceding Examples, wherein the plate is bolted to the first pole brace with at least one bolt.

Example 5 can include, or can optionally be combined with the subject matter of one or any combination of the preceding Examples, wherein the at least one bolt comprises a one-sided bolt.

Example 6 can include, or can optionally be combined with the subject matter of one or any combination of the preceding Examples, wherein the bearing plate is coupled to the second pole via two side plates that straddle opposite edges of the second pole brace, wherein the opposite edges are normal to and adjacent the second edge.

Example 7 can include, or can optionally be combined with the subject matter of one or any combination of the preceding Examples, wherein the bearing plate is welded to the two side plates, and the two side plates are welded to the second pole brace.

Example 8 can include, or can optionally be combined with the subject matter of one or any combination of the preceding Examples, wherein the bearing plate is wider than the first pole brace.

Example 9 can include, or can optionally be combined with the subject matter of one or any combination of the preceding Examples tower of Example 8, comprising an overplate coupled to the plate and the first pole brace, over the bearing plate, such that the bearing plate it disposed between the overplate and the first pole brace.

Example 10 can include, or can optionally be combined with the subject matter of one or any combination of the preceding Examples, wherein the first and second pole braces are shaped like elongate strips to extend vertically along the pole.

Example 11 can include, or can optionally be combined with the subject matter of one or any combination of the preceding Examples tower of Example 1, comprising an overplate coupled to the plate and the first pole brace, over the bearing plate, such that the bearing plate it disposed between the overplate and the first pole brace.

Example 12 can include, or can optionally be combined with the subject matter of one or any combination of the preceding Examples, wherein the overplate is bolted the first pole brace with at least one bolt, with a spacer disposed therebetween, the spacer having a thickness substantially the same as the plate coupled to the first pole brace.

Example 13 can include, or can optionally be combined with the subject matter of one or any combination of the preceding Examples, wherein the at least one bolt comprises a one-sided bolt.

Example 14 can include, or can optionally be combined with the subject matter of one or any combination of the preceding Examples, wherein the first pole brace abuts the second pole brace without elastic deformation of the elongate pole.

Example 15 can include, or can optionally be combined with the subject matter of one or any combination of the preceding Examples, wherein the at least one first bolt and the at least one second bolt each comprise a one-sided bolt.

Example 16 can include a system. An example can include a first pole brace comprising an elongate plate, with an inner side, an outer side and a first edge extending between the inner side and the outer side, the first pole brace to be bolted to an exterior of at least one side of an elongate pole with at least one first bolt such that the inner side of the first pole brace lies along a portion of the exterior of the at least one side of the elongate pole. An example can include a second pole brace comprising an elongate plate with an inner side, an outer side, and a second edge extending between the inner side and the outer side, the second pole brace to be bolted to the at least one side of the elongate pole as the first pole brace with at least one second bolt such that the inner side of the second pole brace lies along a portion of the exterior of the at least one side of the elongate pole, with the first pole brace disposed proximal the first pole brace with the first edge disposed proximal to second edge to abut the second edge during elastic deformation of the elongate pole in a first direction. An example can include a plate coupled to the first pole brace. An example can include a bearing plate coupled to the second pole brace to removably bear against one side of the plate to transmit load between the first pole brace and the second pole brace during elastic deformation of the elongate pole in a second direction, opposite the first.

Example 17 can include, or can optionally be combined with the subject matter of one or any combination of the preceding Examples system of Example 16, wherein the bearing plate is coupled to the second pole via two side plates that straddle opposite edges of the second pole brace, wherein the opposite edges are normal to and adjacent the second edge.

Example 18 can include, or can optionally be combined with the subject matter of one or any combination of the preceding Examples system of Example 17, wherein the bearing plate is welded to the two side plates, and the two side plates are welded to the second pole brace.

Example 19 can include a system. An example can include a first pole brace comprising an elongate plate, with an inner side, an outer side and a first edge extending between the inner side and the outer side, the first pole brace to be fastened to an exterior of at least one side of an elongate pole such that the inner side of the first pole brace lies along a portion of the exterior of the at least one side of the elongate pole. An example can include a second pole brace comprising an elongate plate with an inner side, an outer side, and a second edge extending between the inner side and the outer side, the second pole brace to be fastened to the at least one side of the elongate pole as the first pole brace such that the inner side of the second pole brace lies along a portion of the exterior of the at least one side of the elongate pole, with the first pole brace disposed proximal the first pole brace with the first edge disposed proximal to second edge to abut the second edge during elastic deformation of the elongate pole in a first direction. An example can include a plate coupled to the first pole brace. An example can include a means for bearing the second pole brace removably against one side of the plate and transmitting load between the first pole brace and the second pole brace during elastic deformation of the elongate pole in a second direction, opposite the first.

Example 20 can include, or can optionally be combined with the subject matter of one or any combination of the preceding Examples system of Example 19, wherein the a means for bearing comprise a bearing plate coupled to the second pole brace to removably bear against one side of the plate to transmit load between the first pole brace and the second pole brace during elastic deformation of the elongate pole in a second direction, opposite the first, wherein the bearing plate is wider than each of the first pole brace and the second pole brace.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A telecommunications tower, comprising:
an elongate pole including an exterior with at least one side;
a first pole brace comprising an elongate plate, with an inner side, an outer side and a first edge extending between the inner side and the outer side, the first pole brace bolted to the exterior of the at least one side of the elongate pole with at least one first bolt such that the inner side of the first pole brace lies along a portion of the exterior of the at least one side of the elongate pole;
a second pole brace comprising an elongate plate with an inner side, an outer side, and a second edge extending between the inner side and the outer side, the second pole brace bolted to the at least one side of the elongate pole as the first pole brace with at least one second bolt such that the inner side of the second pole brace lies along a portion of the exterior of the at least one side of the elongate pole, with the first pole brace disposed proximal the first pole brace with the first edge disposed proximal to second edge to abut the second edge during elastic deformation of the elongate pole in a first direction;
a plate coupled to the first pole brace; and
a bearing plate coupled to the second pole brace to removably bear against one side of the plate to transmit load between the first pole brace and the second pole brace during elastic deformation of the elongate pole in a second direction, opposite the first.

2. The tower of claim 1, wherein the bearing plate is welded or bolted to the second pole brace with at least one bolt.

3. The tower of claim 2, wherein the at least one bolt comprises a one-sided bolt.

4. The tower of claim 1, wherein the plate is welded or bolted to the first pole brace with at least one bolt.

5. The tower of claim 4, wherein the at least one bolt comprises a one-sided bolt.

6. The tower of claim 1, wherein the bearing plate is coupled to the second pole brace via two side plates that straddle opposite edges of the second pole brace, wherein the opposite edges are normal to and adjacent the second edge.

7. The tower of claim 6, wherein the bearing plate is welded to the two side plates, and the two side plates are welded to the second pole brace.

8. The tower of claim 1, wherein the bearing plate is wider than the first pole brace.

9. The tower of claim 8, comprising an overplate coupled to the plate and the first pole brace, over the bearing plate, such that the bearing plate it disposed between the overplate and the first pole brace.

10. The tower of claim 1, wherein the first and second pole braces are shaped like elongate strips to extend vertically along the pole.

11. The tower of claim 1, comprising an overplate coupled to the plate and the first pole brace, over the bearing plate, such that the bearing plate it disposed between the overplate and the first pole brace.

12. The tower of claim 11, wherein the overplate is bolted to the first pole brace with at least one bolt, with a spacer disposed therebetween, the spacer having a thickness substantially the same as the plate coupled to the first pole brace.

13. The tower of claim 12, wherein the at least one bolt comprises a one-sided bolt.

14. The tower of claim 1, wherein the first pole brace abuts the second pole brace without elastic deformation of the elongate pole.

15. The tower of claim 1, wherein the at least one first bolt and the at least one second bolt each comprise a one-sided bolt.

16. A system, comprising:
a first pole brace comprising an elongate plate, with an inner side, an outer side and a first edge extending between the inner side and the outer side, the first pole brace to be bolted to an exterior of at least one side of an elongate pole with at least one first bolt such that the inner side of the first pole brace lies along a portion of the exterior of the at least one side of the elongate pole;
a second pole brace comprising an elongate plate with an inner side, an outer side, and a second edge extending between the inner side and the outer side, the second pole brace to be bolted to the at least one side of the elongate pole as the first pole brace with at least one second bolt such that the inner side of the second pole brace lies along a portion of the exterior of the at least one side of the elongate pole, with the first pole brace disposed proximal the first pole brace with the first edge disposed proximal to second edge to abut the second edge during elastic deformation of the elongate pole in a first direction;
a plate coupled to the first pole brace; and
a bearing plate coupled to the second pole brace to removably bear against one side of the plate to transmit load between the first pole brace and the second pole brace during elastic deformation of the elongate pole in a second direction, opposite the first.

17. The system of claim 16, wherein the bearing plate is coupled to the second pole via two side plates that straddle opposite edges of the second pole brace, wherein the opposite edges are normal to and adjacent the second edge.

18. The system of claim 17, wherein the bearing plate is welded to the two side plates, and the two side plates are welded to the second pole brace.

19. A system, comprising:
a first pole brace comprising an elongate plate, with an inner side, an outer side and a first edge extending between the inner side and the outer side, the first pole brace to be fastened to an exterior of at least one side of an elongate pole such that the inner side of the first pole brace lies along a portion of the exterior of the at least one side of the elongate pole;
a second pole brace comprising an elongate plate with an inner side, an outer side, and a second edge extending between the inner side and the outer side, the second pole brace to be fastened to the at least one side of the elongate pole as the first pole brace such that the inner side of the second pole brace lies along a portion of the exterior of the at least one side of the elongate pole, with the first pole brace disposed proximal the first pole brace with the first edge disposed proximal to second edge to abut the second edge during elastic deformation of the elongate pole in a first direction;
a plate coupled to the first pole brace; and
a means for bearing the second pole brace removably against one side of the plate and transmitting load between the first pole brace and the second pole brace during elastic deformation of the elongate pole in a second direction, opposite the first.

20. The system of claim 19, wherein the a means for bearing comprise a bearing plate coupled to the second pole brace to removably bear against one side of the plate to transmit load between the first pole brace and the second pole brace during elastic deformation of the elongate pole in a second direction, opposite the first, wherein the bearing plate is wider than each of the first pole brace and the second pole brace.
